(19) United States
(12) Patent Application Publication
(10) Pub. No.: US 2021/0402568 A1
(43) Pub. Date: Dec. 30, 2021

(54) POLISHING NANOFIBER AGGREGATE AND METHOD FOR PRODUCING SAME

(71) Applicant: M-TECHX INC., Saitama-shi, Saitama (JP)

(72) Inventors: Morihiko IKEGAYA, Saitama-shi, Saitama (JP); Hiroyoshi SOTA, Saitama-shi, Saitama (JP); Toshiki HIROGAKI, Kyotanabe-shi, Kyoto (JP); Eiichi AOYAMA, Kyotanabe-shi, Kyoto (JP); Wei WU, Kyotanabe-shi, Kyoto (JP)

(21) Appl. No.: 16/768,521

(22) PCT Filed: Nov. 29, 2017
(86) PCT No.: PCT/JP2017/042926

§ 371 Date: Sep. 7, 2021

(51) Int. Cl. B24D 11/00

(52) U.S. Cl. CPC B24D 11/001; B82Y 30/00

(57) ABSTRACT

A polishing nanofiber aggregate and a method for producing the same are provided that are capable of suppressing a decrease in polishing efficiency even using fine powder for precision polishing. A polishing nanofiber aggregate 1 is used by adsorbing a slurry prepared by mixing fine powder for precision polishing with a liquid. The polishing nanofiber aggregate 1 has an average fiber diameter d of 400 nm or more and 1000 nm or less and a porosity η of 0.70 or more and 0.95 or less. The polishing nanofiber aggregate 1 is capable of reducing an interfiber distance e₁ while securing the porosity η. It is thus possible to suppress incorporation of abrasive particles having a small diameter between the fibers.

### TECHNICAL FIELD

The present invention relates to a nanofiber aggregate used for polishing and a method for producing the same.

### BACKGROUND ART

Examples of a fiber aggregate used for polishing include nonwoven fabric of resin fibers, felt, and the like. Such a fiber aggregate is immersed in a slurry, such as oil mixed with abrasive particles such as alumina, and pressed and slid against a surface of an object to be polished. The fiber aggregate is thus used for polishing with the abrasive particles while supplying adsorbed oil. For example, PTL 1 discloses a polishing fiber aggregate in the past.

In PTL 1, the polishing means as the polishing fiber aggregate is composed of a felt. The felt has a density of 0.20 g/cm³ or more. The felt is then impregnated with a liquid mixed with abrasive particles.

### CITATION LIST

### Patent Literature

PTL 1: JP 2002-283211 A

### SUMMARY OF INVENTION

### Technical Problem

In such a fiber aggregate, it is possible to secure an amount of oil adsorption by reducing the bulk density (may be referred to as an “apparent density”). Reduction of bulk density, however, causes an increase in interfiber distance. Particularly in a fiber aggregate, such as a felt in the past, resin fibers having a diameter on the order of micrometers are used and thus the interfiber distance is relatively large. Reduction of bulk density causes an even greater increase in interfiber distance. Accordingly, polishing using abrasive particles having a small diameter, such as fine powder for precision polishing, causes incorporation of the abrasive particles between the fibers. This causes a decrease in the abrasive particles in contact with a surface of the object to be polished. There is thus a problem of a decrease in polishing efficiency.

It is an object of the present invention to provide a polishing nanofiber aggregate capable of suppressing a decrease in polishing efficiency even using fine powder for precision polishing and a method for producing the same.

### Solution to Problem

The present inventors focused on relationship between the size of abrasive particles used for polishing and the interfiber distance of a polishing nanofiber aggregate and made intensive investigation on the structure of the polishing nanofiber aggregate. As a result, they found that the structure of the polishing nanofiber aggregate is specified by an average fiber diameter and a porosity, which is a parameter closely related to the bulk density and thus completed the present invention.

To achieve the above object, a polishing nanofiber aggregate according to an aspect of the present invention is a polishing nanofiber aggregate configured to be used by adsorbing a slurry prepared by mixing fine powder for precision polishing with a liquid, wherein

formulae (i) and (ii) below are satisfied where the polishing nanofiber aggregate has an average fiber diameter of d and a porosity of η.

(i) 400 nm≤d≤1000 nm
(ii) 0.70≤η≤0.95

In the present invention, it is preferred that a formula (iii) below is satisfied where the fine powder for precision polishing has an average particle diameter of dg.

$$\begin{matrix}[ Math . 1 ] & \\ \frac{d}{{d}_{g}} ( \sqrt{\frac{3 π}{4 ( 1 - η )} - 1} ) < 1 & ( iii )\end{matrix}$$

To achieve the above object, a method for producing a polishing nanofiber aggregate of the present invention is a method for producing a polishing nanofiber aggregate configured to be used by adsorbing a slurry prepared by mixing fine powder for precision polishing with a liquid, the method including the steps of:

aggregating nanofibers having an average fiber diameter of d; and

forming the aggregated nanofibers to have a porosity of ii, wherein

the porosity η satisfies a formula (iv) below where the fine powder for precision polishing has an average particle diameter of dg.

$$\begin{matrix}[ Math . 2 ] & \\ η < 1 - \frac{3 π}{4 {( \frac{{d}_{g}}{d} + 1 )}^{2}} & ( iv )\end{matrix}$$

### Advantageous Effects of Invention

The present invention allows reduction of the interfiber distance while securing the porosity. It is thus possible to suppress incorporation of abrasive particles having a small diameter between the fibers. Accordingly, it is possible to effectively suppress a decrease in polishing efficiency even using fine powder for precision polishing.

### BRIEF DESCRIPTION OF THE DRAWINGS

FIG. 1 are illustrations of a polishing nanofiber aggregate according to an embodiment of the present invention.

FIG. 2 is a perspective view illustrating an example of a production device used for preparation of the polishing nanofiber aggregate in FIG. 1.

FIG. 3 is a side view including a partial cross section of the production device in FIG. 2.

FIG. 4 is a front view of a collecting net for deposition of nanofibers by the production device in FIG. 2.

FIG. 5 are diagrams illustrating a structural model of a polishing fiber aggregate.

FIG. 6 are diagrams of the model in FIG. 5 taken from directions of the respective axes.

FIG. 7 is a graph illustrating relationship between porosity and interfiber distance in fiber aggregates.

FIG. 8 are diagrams schematically illustrating relationship between fibers constituting polishing fiber aggregates and abrasive particles.

FIG. 9 are diagrams illustrating a device used for polishing.

FIG. 10 are graphs illustrating relationship between polishing time and arithmetic average roughness (pressing force of 10 N).

FIG. 11 are graphs illustrating relationship between polishing time and removal amount from polishing (pressing force of 10 N).

FIG. 12 are graphs illustrating relationship between polishing time and arithmetic average roughness (pressing force of 20 N).

FIG. 13 are graphs illustrating relationship between polishing time and removal amount from polishing (pressing force of 20 N).

FIG. 14 are graphs illustrating relationship of a ratio of an interfiber distance to an average particle diameter of abrasive particles with arithmetic average roughness and removal amount from polishing.

### DESCRIPTION OF EMBODIMENTS

A polishing nanofiber aggregate according to an embodiment of the present invention is described below.

### Composition of Polishing Nanofiber Aggregate

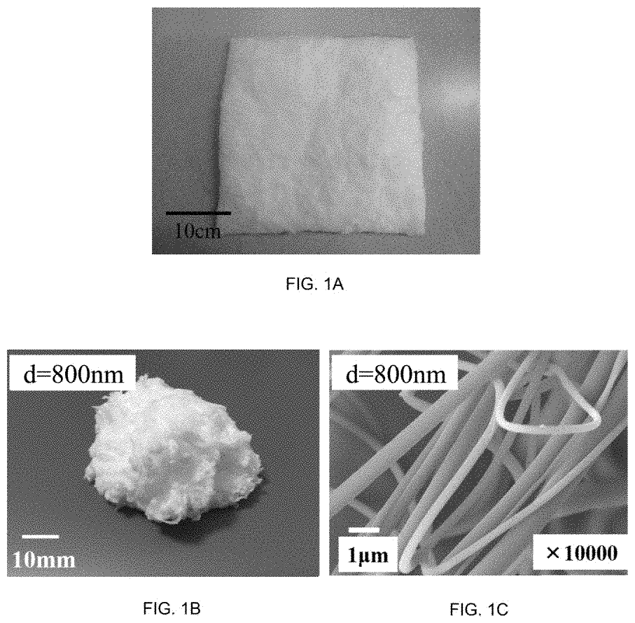

The composition of a polishing nanofiber aggregate in the present embodiment is described first with reference to FIG. 1.

FIG. 1 are illustrations of a polishing nanofiber aggregate according to an embodiment of the present invention. Specifically, FIG. 1A is a front photograph of an example of the polishing nanofiber aggregate. FIG. 1B is a photograph of an example of a non-formed nanofiber aggregate. FIG. 1C is an enlarged photograph of an example of the polishing nanofiber aggregate taken with an electron microscope.

A polishing nanofiber aggregate 1 in the present embodiment is used by adsorbing a slurry prepared by mixing fine powder for precision polishing, as abrasive particles, with a liquid. The polishing nanofiber aggregate 1 is composed by aggregating fine fibers having a fiber diameter on the order of nanometers, so-called nanofibers. The polishing nanofiber aggregate 1 has an average fiber diameter d of 800 nm. The polishing nanofiber aggregate 1 may be composed by aggregating nanofibers having an average fiber diameter d other than 800 nm. The polishing nanofiber aggregate 1 is formed in a square mat shape as illustrated in FIG. 1A. The polishing nanofiber aggregate 1 may be formed in a shape in accordance with usage and the like, such as a circular shape, a hexagonal shape, or the like other than a square shape. FIG. 1B illustrates a non-formed aggregate of nanofibers having an average fiber diameter of 800 nm. FIG. 1C illustrates a state of the nanofiber aggregate having an average fiber diameter of 800 nm enlarged with an electron microscope.

In the present embodiment, the nanofibers constituting the polishing nanofiber aggregate 1 are formed of a synthetic resin. Examples of the synthetic resin include polypropylene (PP), polyethylene terephthalate (PET), and the like. The nanofibers may be formed of a material other than them.

In particular, polypropylene is water repellent and oil adsorbent. Polypropylene fiber aggregates have performance of adsorbing oil several tens of times more than its own weight. Polypropylene is thus preferred as a material for the polishing nanofiber aggregate 1. The numerical values disclosed by raw material suppliers as the density of polypropylene range approximately from 0.85 to 0.95. Polypropylene has a contact angle with oil from 29 degrees to 35 degrees. The density of polypropylene used herein is 0.895 g/cm³.

The polishing nanofiber aggregate 1 satisfies formulae (i) and (ii) below where the polishing nanofiber aggregate 1 has an average fiber diameter of d and a porosity of η.

(i) 400 nm≤d≤1000 nm
(ii) 0.70≤η≤0.95

The average fiber diameter d is obtained as follows. In the polishing nanofiber aggregate 1, a plurality of spots are arbitrarily selected and enlarged with an electron microscope. In each spot enlarged with the electron microscope, a plurality of nanofibers are arbitrarily selected to measure the diameters. The diameters of the selected nanofibers are then averaged to be defined as the average fiber diameter d. In the present embodiment, five spots are arbitrarily selected in the polishing nanofiber aggregate 1 and 20 nanofibers are arbitrarily selected in each spot to measure the diameters. Then, the average of the diameters of these 100 nanofibers is defined as the average fiber diameter d. As an example, the polishing nanofiber aggregate 1 in the present embodiment has an average fiber diameter of 800 nm and fiber diameters with a standard deviation of 440 and a coefficient of variation of 0.55. The coefficient of variation is a value obtained by dividing the standard deviation by the average fiber diameter and is preferably 0.6 or less.

The porosity η is a parameter related to a bulk density ρ_{b}. The relationship between the porosity η and the bulk density ρ_{b} is expressed by a formula (4) described later.

The polishing nanofiber aggregate 1 in the present embodiment satisfies a formula (iii) below where the fine powder for precision polishing has an average particle diameter of dg.

$$\begin{matrix}[ Math . 3 ] & \\ \frac{d}{{d}_{g}} ( \sqrt{\frac{3 π}{4 ( 1 - η )} - 1} ) < 1 & ( iii )\end{matrix}$$

Satisfaction of the formula (iii) above causes an interfiber distance e₁ described later of the polishing nanofiber aggregate 1 to be smaller than an average particle diameter d_{g} of the abrasive particles. It is thus possible to suppress incorporation of the abrasive particles between the fibers. The formula (iii) above is led from a formula (5) described later and a ratio (e₁/d_{g}) of the interfiber distance e₁ to the average particle diameter d_{g} of the abrasive particles. The formula (iii) above is equivalent to a formula “e₁/d_{g}<1”.

The fine powder for precision polishing as the abrasive particles includes those defined in JIS R6001, and as an example, the present embodiment is intended for those with a particle size of #220 (average particle diameter d_{g}=74 μm) and with a particle size of #600 (average particle diameter d_{g}=30 μm). Of course, the fine powder for precision polishing is not limited to them.

### Device and Method for Producing Polishing Nanofiber Aggregate

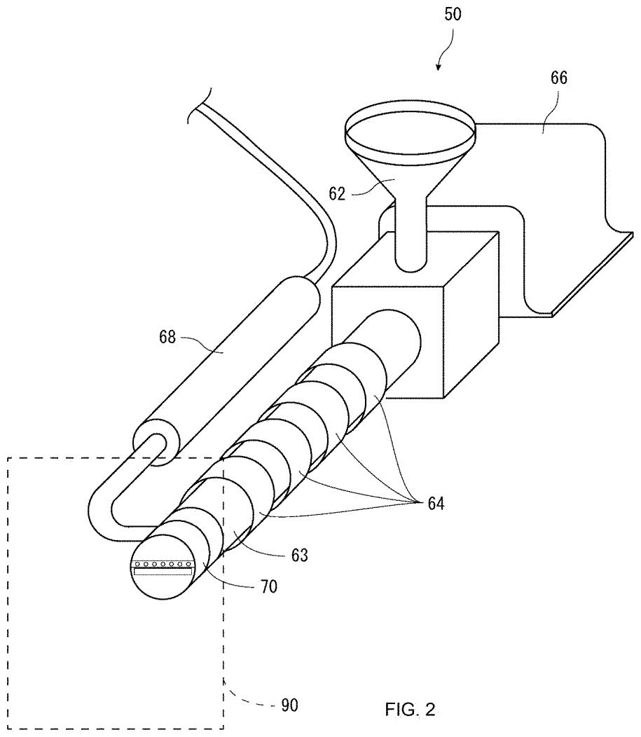

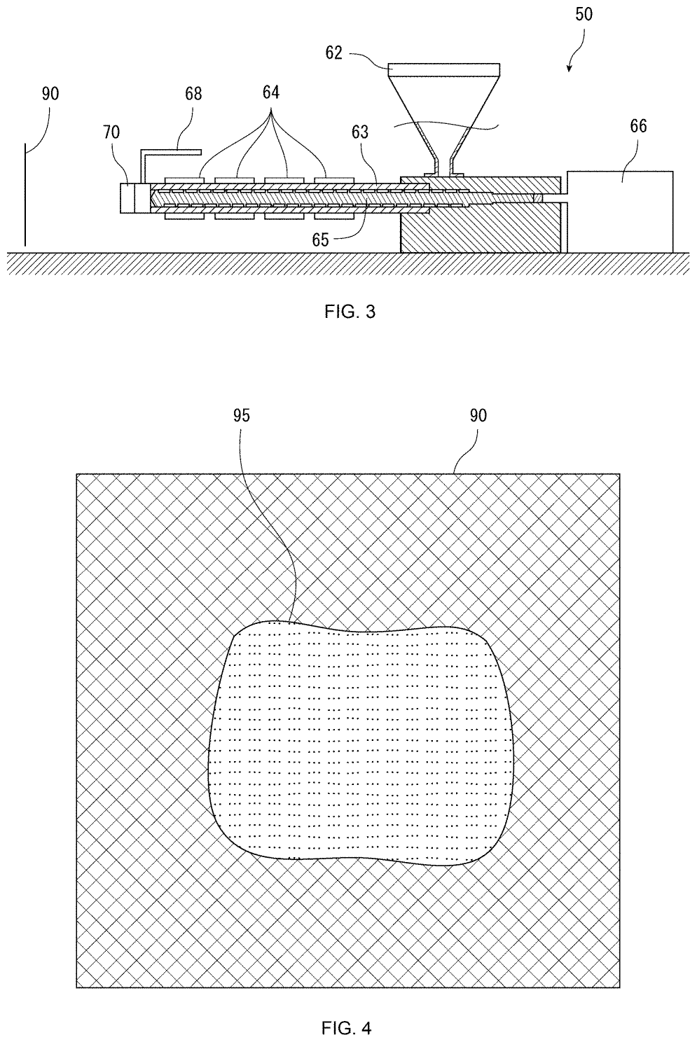

The polishing nanofiber aggregate 1 in the present embodiment is produced using a production device illustrated in FIGS. 2 through 4. FIG. 2 is a perspective view illustrating an example of a production device used for preparation of the polishing nanofiber aggregate in FIG. 1. FIG. 3 is a side view including a partial cross section of the production device in FIG. 2. FIG. 4 is a front view of a collecting net for deposition of nanofibers produced by the production device in FIG. 2.

As illustrated in FIGS. 2 and 3, a production device 50 has a hopper 62, a heating cylinder 63, heaters 64, a screw 65, a motor 66, and a head 70.

Into the hopper 62, a synthetic resin in the form of pellets is fed to be the material for the nanofibers. The heating cylinder 63 is heated by the heaters 64 to melt the resin supplied from the hopper 62. The screw 65 is accommodated in the heating cylinder 63. The screw 65 is rotated by the motor 66 to deliver the molten resin to a distal end of the heating cylinder 63. The head 70 in a cylindrical shape is provided at the distal end of the heating cylinder 63. To the head 70, a gas supply section, not shown, is connected via a gas supply pipe 68. The gas supply pipe 68 is provided with a heater to heat high pressure gas supplied from the gas supply section. The head 70 injects the high pressure gas to the front and also discharges the molten resin so as to be carried on the high pressure gas flow. In front of the head 70, a collecting net 90 is arranged.

Now, operation of the production device 50 in the present embodiment is described. The raw material (resin) in the form of pellets fed into the hopper 62 is supplied into the heating cylinder 63. The resin melted in the heating cylinder 63 is delivered to the distal end of the heating cylinder 63 by the screw 65. The molten resin (molten raw material) reaching the distal end of the heating cylinder 63 is discharged from the head 70. In coincidence with the discharge of the molten resin, high pressure gas is blown from the head 70.

The molten resin discharged from the head 70 intersects with the gas flow at a predetermined angle and is carried forward while being drawn. The drawn resin becomes fine fibers to be aggregated, as illustrated in FIG. 4, on the collecting net 90 arranged in front of the head 70 (aggregation step). The aggregated fine fibers 95 are then formed in a desired shape (e.g., square mat shape) to cause the porosity η to satisfy a formula (iv) (formation step). The polishing nanofiber aggregate 1 of the present invention is thus obtained.

$$\begin{matrix}[ Math . 4 ] & \\ η < 1 - \frac{3 π}{4 {( \frac{{d}_{g}}{d} + 1 )}^{2}} & ( iv )\end{matrix}$$

Satisfaction of the formula (iv) above allows the interfiber distance e₁ described later of the polishing nanofiber aggregate 1 to be smaller than the average particle diameter d_{g} of the abrasive particles. It is thus possible to suppress incorporation of the abrasive particles between the fibers. The formula (iv) above is led from the formula (5) described later and the ratio (e₁/d_{g}) of the interfiber distance e₁ to the average particle diameter d_{g} of the abrasive particles.

It should be noted that, although configured to discharge the “molten raw material” obtained by heating a synthetic resin to be a raw material to melt the resin, the above production device 50 is not limited to this configuration. In addition to this configuration, the production device 50 may be configured to, for example, discharge a “solvent” where a solid or liquid raw material as a solute is dissolved in advance at a predetermined concentration relative to a predetermined solvent. The present applicant discloses, as an example of a production device applicable to production of the polishing nanofiber aggregate 1, a nanofiber production device and a nanofiber production method in Japanese Patent Application No. 2015-065171. The application was granted a patent (Japanese Patent No. 6047786, filed on Mar. 26, 2015 and registered on Dec. 2, 2016) and the present applicant holds the patent right.

### Modeling of Polishing Fiber Aggregate

The present inventors attempted to specify the structure of the fiber aggregate having a structure in which many fibers are complexly entangled with each other. The present inventors construed the structure of the fiber aggregate by simplification and developed a model by assuming that the fiber aggregate contains a plurality of fibers extending in three directions orthogonal to each other in a minimum calculation unit in a cubic shape.

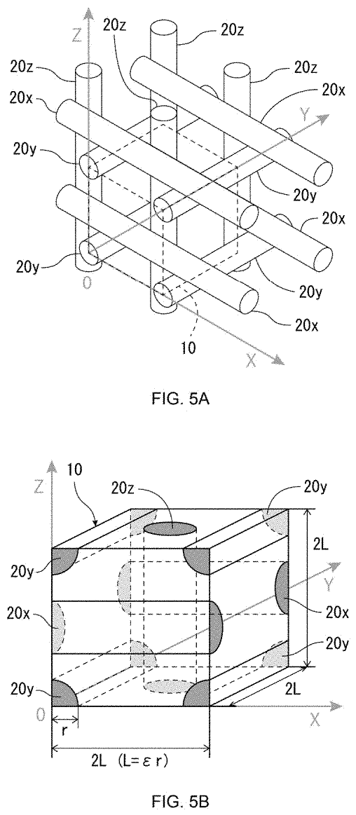

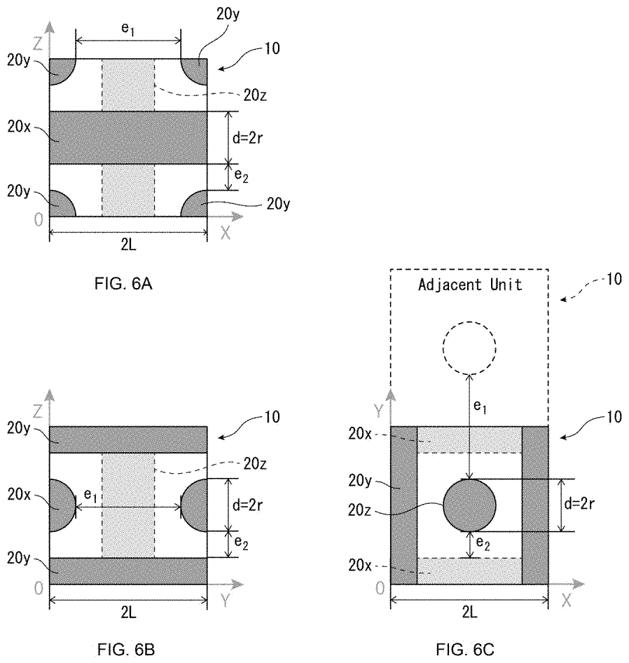

FIGS. 5 and 6 illustrate the model thus developed. FIG. 5A is a perspective view illustrating a three-direction model and a unit-calculation unit of the fiber aggregate. FIG. 5B is a perspective view of the minimum calculation unit. FIGS. 6A, 6B, and 6C are diagrams of the minimum calculation unit taken from the Y axis direction, the X axis direction, and the Z axis direction. In FIG. 6C, an adjacent minimum calculation unit (adjacent unit) is indicated by a broken line.

As illustrated in FIGS. 5 and 6, in a three-dimensional space represented by the X, Y, and Z axes, a minimum calculation unit 10 has a cubic shape with each side 2L in length. The minimum calculation unit 10 includes fiber portions 20x, 20y, and 20z. The fiber portions 20x have the central axis located on two planes in parallel with the X axis and the Z axis and extending in the X axis direction. The fiber portions 20x have a cross-sectional shape of a semicircular shape obtained by bisecting a circle. The fiber portions 20y have the central axis coinciding with four sides in parallel with the Y axis and extending in the Y axis direction. The fiber portions 20y have a cross-sectional shape of a sector obtained by quadrisecting a circle. The fiber portion 20z has the central axis extending in the Z axis direction through the center of two planes in parallel with the X axis and the Y axis. The fiber portion 20z has a cross-sectional shape of a circular shape. The fiber portions 20x, 20y, and 20z are arranged at intervals to each other. The total volume of the fiber portions 20x, the total volume of the fiber portions 20y, and the volume of the fiber portion 20z are identical.

In the minimum calculation unit 10, a length coefficient c can be expressed by a formula (1) below where r denotes the fiber radius and 2L denotes the distance between the central axes of parallel fibers.

$$\begin{matrix}[ Math . 5 ] & \\ ɛ = \frac{L}{r} ( ɛ \geq 1 , 2 L = 2 ɛ r = ɛ d ) & ( 1 )\end{matrix}$$

In addition, the relationship of a formula (2) below holds for a mass m of the minimum calculation unit 10, a volume of V, a fiber diameter of d=2r, and a fiber density of ρ. It should be noted that the density ρ of each fiber constituting the polishing nanofiber aggregate 1 in the present embodiment is considered to be equivalent to the density of polypropylene in a solid state. In the calculation below, the density of polypropylene is thus used as the fiber density ρ.

[Math. 6]

m=6πr²Lρ (2)

The polishing fiber aggregate has a bulk density ρ_{b} that can be expressed by a formula (3) below.

$$\begin{matrix}[ Math . 7 ] & \\ {ρ}_{b} = \frac{m}{V} = \frac{6 π {r}^{2} L ρ}{8 {L}^{3}} = \frac{3 π}{4 {ɛ}^{2}} ρ & ( 3 )\end{matrix}$$

The polishing fiber aggregate has a porosity η (free volume η) that can be expressed by a formula (4) below.

$$\begin{matrix}[ Math . 8 ] & \\ η = \frac{8 {L}^{3} - 6 π {r}^{2} L}{8 {L}^{3}} = 1 - \frac{3 π}{4 {ɛ}^{2}} = 1 - \frac{{ρ}_{b}}{ρ} & ( 4 )\end{matrix}$$

An interfiber distance e₁ (gap e₁) can be expressed by a formula (5) below.

$$\begin{matrix}[ Math . 9 ] & \\ {e}_{1} = 2 L - 2 r = d ( \sqrt{\frac{3 π}{4 ( 1 - η )} - 1} ) & ( 5 )\end{matrix}$$

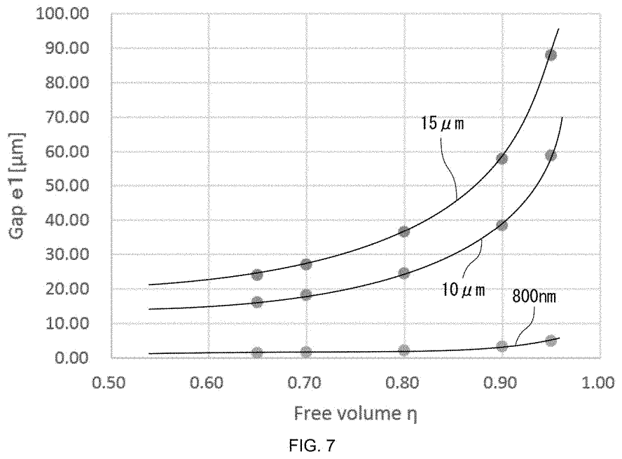

FIG. 7 illustrates a graph created using the result of calculating the formula (5). This graph illustrates the relationship between the porosity η and the interfiber distance e₁ in each of a plurality of polishing fiber aggregates constituted by fibers with different average fiber diameters d.

As illustrated in the graph of FIG. 7, fiber aggregates with an average fiber diameter d on the order of micrometers (10 μm and 15 μm) has an interfiber distance e₁ of 15 μm or more for a porosity η of 0.6 or more. In addition, a greater porosity η causes an even greater interfiber distance e₁. In contrast, a fiber aggregate with an average fiber diameter d on the order of micrometers (800 nm) has a very small interfiber distance e₁ approximately from 1 to 4 μm for a porosity of 0.6 or more. In addition, a variation in interfiber distance e₁ with a variation in porosity η is relatively moderate. Moreover, as clearly understood from the graph, when the porosity η is constant, a smaller average fiber diameter d causes a smaller interfiber distance e₁.

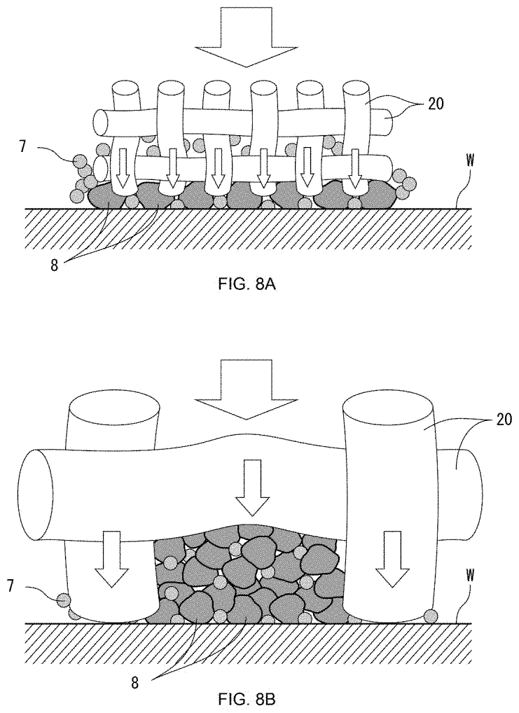

FIG. 8 schematically illustrate relationship between the fibers constituting the polishing fiber aggregates and the abrasive particles. The porosities η in FIGS. 8A and 8B are identical, where FIG. 8A illustrates a configuration in which the average fiber diameter d is small and FIG. 8B illustrates a configuration in which the average fiber diameter d is large. In FIGS. 8A and 8B, the reference sign 20 denotes the fibers constituting the polishing fiber aggregates, the reference sign 7 denotes the oil, the reference sign 8 denotes the abrasive particles, the reference sign W denotes the object to be polished, and each arrow denotes a pressing force against the object to be polished.

As illustrated in FIG. 8A, the configuration with a small average fiber diameter d causes a smaller interfiber distance e₁. Incorporation of the abrasive particles 8 between the fibers 20 is thus suppressed and the pressing force is efficiently applied to the abrasive particles through each fiber 20. It is accordingly possible to press a relatively large number of abrasive particles against the object W to be polished to allow efficient polishing.

In contrast, as illustrated in FIG. 8B, the configuration with a large average fiber diameter d causes a greater interfiber distance e₁. The large number of abrasive particles 8 thus result in incorporation between the fibers 20. In addition, some of the fibers 20 directly contact the object W to be polished and thus the pressing force partly escapes to the object W to be polished. Accordingly, the abrasive particles 8 in contact with the object W to be polished decrease and the ratio of the force applied to the abrasive particles 8 in the pressing force is reduced, resulting in a decrease in polishing efficiency.

In the polishing nanofiber aggregate 1 configured to have an average fiber diameter d of 400 nm and a porosity of 0.7, the interfiber distance e₁ obtained from the formula (5) is 0.72 μm. In the polishing nanofiber aggregate 1 configured to have an average fiber diameter d of 1000 nm and a porosity of 0.95, the interfiber distance e₁ obtained from the formula (5) is 5.86 μm.

### First Verification

The present inventors prepared polishing fiber aggregates described below in Example 1 and Comparative Example 1 of the present invention and performed polishing on a surface of an object to be polished using them. The present inventors then verified the above model theory from the results of polishing.

### Example 1

Using the production device 50 described above, fine fibers 95 having an average fiber diameter d of 800 nm were produced from polypropylene as a material. The deposited fine fibers 95 were formed into 10 cm square in a plan view to have a bulk density of 0.09 g/cm³ (porosity of 0.90) to obtain the polishing nanofiber aggregate 1 in Example 1. When Example 1 was applied to the above model, the interfiber distance e₁ calculated from the formula (5) became 3.1 μm.

### Comparative Example 1

Using the production device 50 described above, fine fibers 95 having an average fiber diameter d of 15 μm were produced from polypropylene as a material. The fine fibers 95 deposited on the collecting net 90 were formed into 10 cm square in a plan view to have a bulk density of 0.09 g/cm³ (porosity of 0.90) to obtain the polishing nanofiber aggregate in Comparative Example 1. When Comparative Example 1 was applied to the above model, the interfiber distance e₁ calculated from the formula (5) became 57.6 μm.

### Test

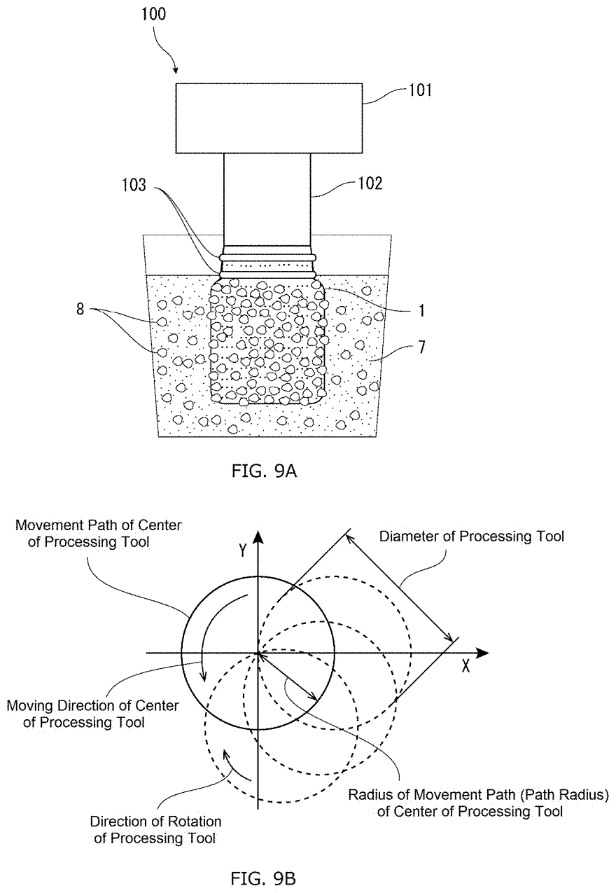

Using a three-axis controlled vertical machining center (ROBODRILL α-T14 Dse, manufactured by Fanuc Corp.) as a processing device, an object to be polished was polished. FIG. 9A schematically illustrates the vicinity of the spindle of the processing device with the polishing fiber aggregate fixed thereto and an abrasive. As illustrated in FIG. 9A, the polishing fiber aggregates (indicated by the reference sign 1 in FIG. 9) in Example 1 and Comparative Example 1 were fixed, with cable ties 103, to a processing tool 102 in a cylindrical shape (φ 10) attached to a spindle 101 of the processing device 100. Then, two types of abrasive were prepared by mixing oil 7 (high viscosity utility oil SUPER LUBE (ISO VG 145), available from Kyodo International Corp.) with the abrasive particles 8 (alumina with a particle size of #220 or #600). The polishing fiber aggregates were sufficiently immersed in the abrasive. The polishing fiber aggregates were then contacted with the surface of the object to be polished. The polishing fiber aggregates were moved on the surface to make a path illustrated in FIG. 9B at a rotational speed of 750 rev./min., a pressing force of 10 N/20 N (0.13 MPa/0.25 MPa), a feed rate of 10 mm/min., and a path radius of 5 mm. The object to be polished was formed in a disk shape with a diameter of 30 mm and a thickness of 5 mm using a cold die steel SKD 11 ([HRC] 60).

### Evaluation

For evaluation, the arithmetic average roughness Ra of the surface of the object to be polished and the removal amount Mₚ from polishing were used as indices. The arithmetic surface roughness Ra was measured using a contact-type surface roughness tester (surface roughness shape measuring instrument E-35B, manufactured by Tokyo Seimitsu Co., Ltd.). The removal amount M_{P} from polishing was measured using a precision electronic balance (Aspro Compact electronic balance OH-42 B, manufactured by As One Corp.). Each object to be polished was polished for 120 minutes as the polishing time. During the polishing, the arithmetic average roughness Ra and the removal amount M_{P} from polishing were measured every 30 minutes. Using two types of abrasive containing abrasive particles with a particle size of #220 (average particle diameter of approximately 74 μm) and abrasive particles with a particle size of #600 (average particle diameter of approximately 30 μm), the measurements were performed for a pressing force of 10 N and 20 N.

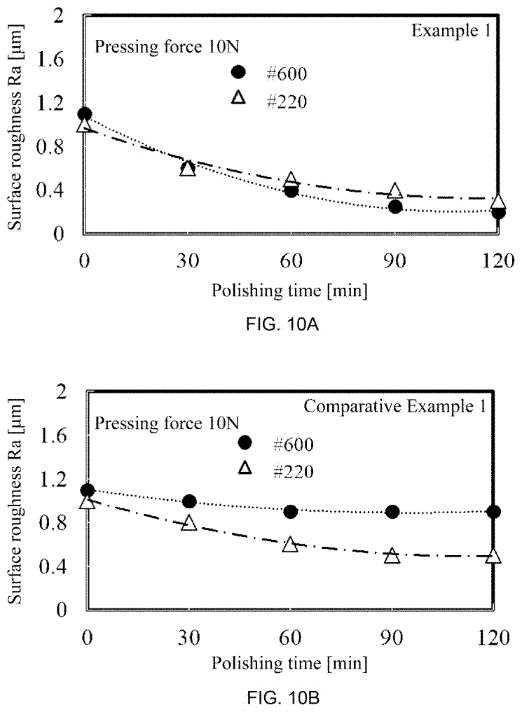

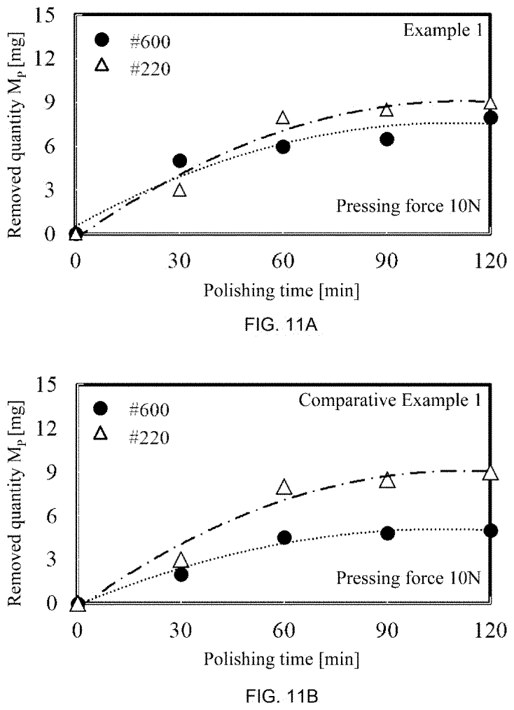

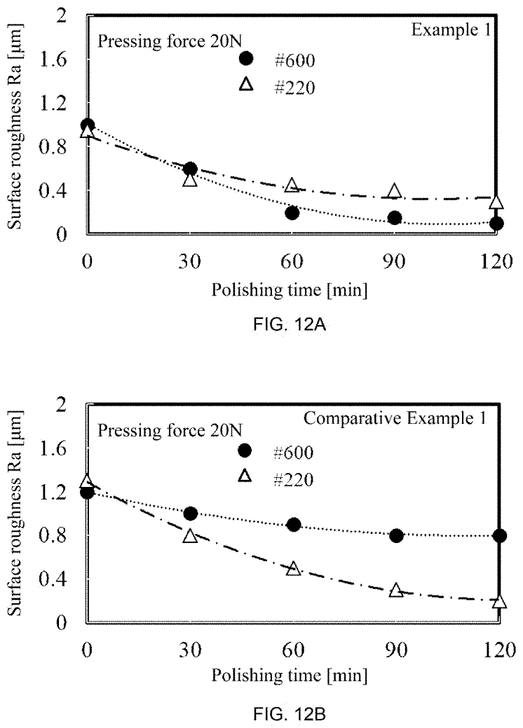

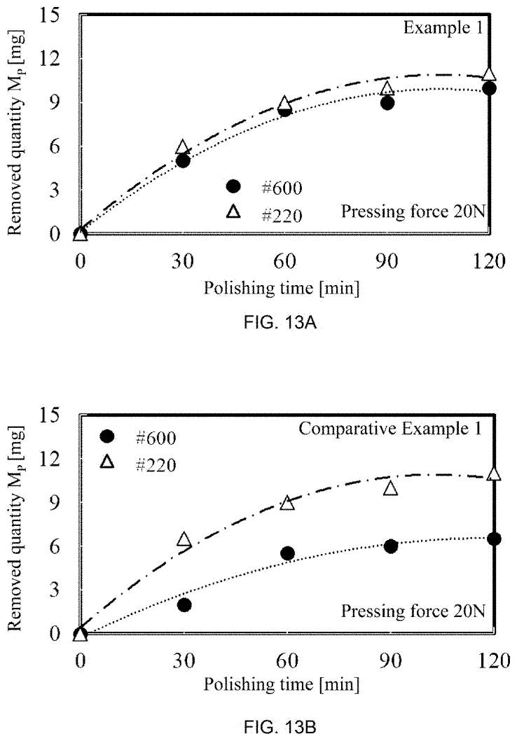

FIGS. 10 to 13 illustrate graphs on which measurement results are plotted. In these drawings, the those suffixed with A illustrate the measurement results in Example 1 and those with B illustrate the measurement results in Comparative Example 1. FIGS. 10 and 11 are graphs illustrating the measurement results of the arithmetic surface roughness Ra and the removal amount M_{P} from polishing for a pressing force of 10 N. FIGS. 12 and 13 are graphs illustrating the measurement results of the arithmetic surface roughness Ra and the removal amount M_{P} from polishing for a pressing force of 20 N.

In the graph illustrated in each drawing, the measurement results at the polishing time of 90 minutes and 120 minutes indicate the roughly same value. It is thus considered that the variations in the arithmetic average roughness Ra and the removal amount M_{P} from polishing settle at the time of 120 minutes when the polishing is finished. In addition, as long as the abrasive particles are not incorporated between the fibers as illustrated in FIG. 8, differences in measurement results due to the difference in particle size of the abrasive particles are assumed to be small at the time of settling the measurement results. The measurement results were thus evaluated based on evaluation criteria below.

### (1) Arithmetic Average Roughness Ra

OK: the difference in measurement results due to the difference in particle size was less than 0.3 μm at the end of processing.
NG: the difference in measurement results due to the difference in particle size was 0.3 μm or more at the end of processing.
(2) Removal Amount M_{P} from Polishing
OK: the difference in measurement results due to the difference in particle size was less than 3 mg at the end of processing.
NG: the difference in measurement results due to the difference in particle size was 3 mg or more at the end of processing.

### (3) Overall Evaluation

OK: both evaluation results of the arithmetic average roughness Ra and the removal amount M_{P} from polishing were good (OK).
NG: evaluation results of the arithmetic average roughness Ra and the removal amount M_{P} from polishing include a failure (NG).

Table 1 shows the evaluation results.

| | | Pressing Force 10N | | Pressing Force 20N | | |
|---|---|---|---|---|---|---|
| | | Arithmetic | Removal | Arithmetic | Removal | |
| | | Surface | Amount from | Surface | Amount from | |
| | | Roughness | Polishing | Roughness | Polishing | overall |
| | | Ra [μm] | M_{P} [mg] | Ra [μm] | M_{P} [mg] | evaluation |
| Example 1 | Difference in | 0.1 | 1 | 0.2 | 1 | OK |
| | Measurement | | | | | |
| | Results | | | | | |
| | Evaluation | OK | OK | OK | OK | |
| Comparative | Difference in | 0.5 | 4 | 0.8 | 4 | NG |
| Example 1 | Measurement | | | | | |
| | Results | | | | | |
| | Evaluation | NG | NG | NG | NG | |

For a pressing force of 10 N, in Example 1 in FIG. 10A, polishing with both abrasive particles having a particle size of #220 and #600 proceeded to the arithmetic average roughness Ra approximately from 0.2 to 0.3 μm. The difference between them was approximately 0.1 μm. In Comparative Example 1 in FIG. 10B, polishing with the abrasive particles having a particle size of #220 proceeded to the arithmetic average roughness Ra of approximately 0.5 μm. However, polishing with the abrasive particles having a particle size of #600 proceeded not sufficiently, only to the arithmetic average roughness Ra of approximately 1.0 μm. The difference between them was approximately 0.5 μm, which is large compared with Example 1.

In Example 1 in FIG. 11A, polishing with both abrasive particles having a particle size of #220 and #600 proceeded to the removal amount M_{P} from polishing approximately from 8 to 9 mg. The difference between them was approximately 1 mg. Meanwhile, in Comparative Example 1 in FIG. 11B, polishing with the abrasive particles having a particle size of #220 proceeded to the removal amount M_{P} from polishing of approximately 9 mg. However, polishing with the abrasive particles having a particle size of #600 proceeded not sufficiently, only to the removal amount M_{P} from polishing of approximately 5 mg. The difference between them was approximately 4 mg, which is large compared with Example 1.

For a pressing force of 20 N, a similar tendency was observed. In Example 1 in FIG. 12A, polishing with both abrasive particles having a particle size of #220 and #600 proceeded to the arithmetic average roughness Ra approximately from 0.1 to 0.3 μm. The difference between them was approximately 0.2 Meanwhile, in Comparative Example 1 in FIG. 12B, polishing with the abrasive particles having a particle size of #220 proceeded to the arithmetic average roughness Ra of approximately 0.2 However, polishing with the abrasive particles having a particle size of #600 was proceeded not sufficiently, only to the arithmetic average roughness Ra of approximately 1.0 μm. The difference between them was approximately 0.8 μm, which is large compared with Example 1.

In Example 1 in FIG. 13A, polishing with both abrasive particles having a particle size of #220 and #600 proceeded to the removal amount M_{P} from polishing approximately from 10 to 11 mg. The difference between them was approximately 1 mg. Meanwhile, in Comparative Example 1 in FIG. 13B, polishing with the abrasive particles having a particle size of #220 proceeded to the removal amount M_{P} from polishing of approximately 11 mg. However, polishing with the abrasive particles having a particle size of #600 proceeded not sufficiently, only to the removal amount M_{P} from polishing of approximately 7 mg. The difference between them was approximately 4 mg, which is large compared with Example 1.

In Example 1, polishing was satisfactory with both abrasive particles having a particle size of #220 and #600. In contrast, in Comparative Example 1, polishing was satisfactory with the abrasive particles having a particle size of #220 while polishing was insufficient with the abrasive particles having a particle size of #600. The results are considered to be because of the relationship between the interfiber distance and the size (diameter) of the abrasive particles.

The interfiber distance e₁ in Example 1 was approximately 3 μm, which is sufficiently small compared with the abrasive particles with a particle size of #220 (average particle diameter d_{g}=74 μm) and the abrasive particles with a particle size of #600 (average particle diameter d_{g}=30 μm). It is thus considered that the abrasive particles were not incorporated between the fibers to allow efficient polishing.

In contrast, the interfiber distance e₁ in Comparative Example 1 was approximately 58 μm, which is small compared with the abrasive particles with a particle size of #220. However, the interfiber distance e₁ is large compared with the abrasive particles with a particle size of #600. It is thus considered that polishing was efficient with the abrasive particles having a particle size of #220 similar to Example 1 while the abrasive particles with a particle size of #600 were incorporated between the fibers not to allow efficient polishing. From these results, the model described above was thus confirmed to be useful.

### Second Verification

The present inventors further prepared multiple types of polishing fiber aggregate having an identical porosity η (0.90) and different average fiber diameters d. Each polishing fiber aggregate was then subjected to polishing with the abrasive particles having a particle size of #220 and #600 for 120 minutes similar to above, followed by measurement of the arithmetic average roughness Ra and the removal amount M_{P} from polishing. The present inventors verified the above model theory from the measurement results.

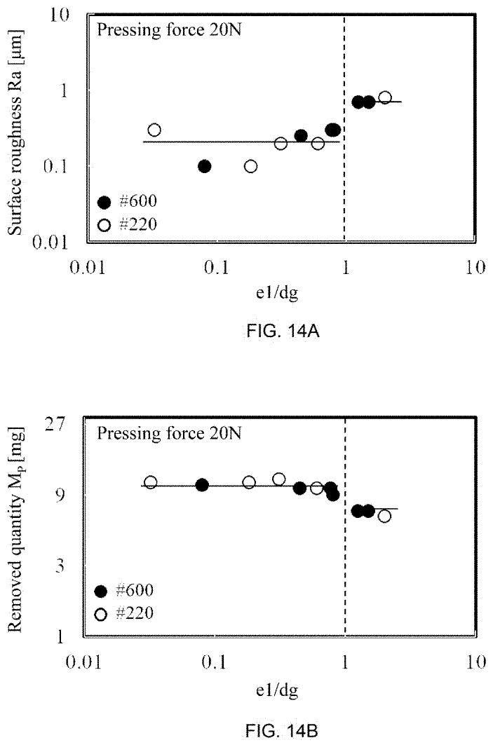

FIG. 14 illustrate results of plotting, for the measurement results of each polishing fiber aggregate, the ratio (e₁/d_{g}) of the interfiber distance e₁ calculated by the formula (5) to the average particle diameter d_{g} of the abrasive particles on the abscissa and the arithmetic average roughness Ra and the removal amount M_{P} from polishing on the respective ordinates.

As illustrated in FIGS. 14A and 14B, significant differences appear in the arithmetic average roughness Ra and the removal amount M_{P} from polishing at the boundary of the above ratio (e₁/d_{g}) of 1. That is, when the above ratio is less than 1, the arithmetic average roughness Ra is small and the removal amount M_{P} from polishing is large, allowing efficient polishing. In particular, the above ratio of 0.3 or less results in effective polishing. That is, e₁/d_{g} 0.3 is more preferred. On the contrary, when the above ratio is more than 1, the arithmetic average roughness Ra is large and the removal amount M_{P} from polishing is small, not allowing efficient polishing.

It is considered that, when the above ratio is less than 1, the average particle diameter d_{g} of the abrasive particles is greater than the interfiber distance e₁ and it is possible to suppress incorporation of the abrasive particles between the fibers, allowing efficient polishing. It is considered that, when the above ratio is more than 1, the average particle diameter d_{g} of the abrasive particles is smaller than the interfiber distance e₁ and the abrasive particles turn out to be incorporated between the fibers, reducing efficient polishing. From these results as well, the model described above was thus confirmed to be useful.

Although the embodiments of the present invention have been described above, the present invention is not limited to these examples. The above embodiments subjected to addition, deletion, and/or design change of components appropriately by those skilled in the art and those having the characteristics of the embodiments appropriately combined are included in the scope of the present invention as long as including the spirit of the present invention.

### REFERENCE SIGNS LIST

1 Polishing Nanofiber Aggregate
7 Oil
8 Abrasive Particle
10 Minimum Calculation Unit
20 Fiber
20x, 20y, and 20z Fiber Portion
50 Production Device
62 Hopper
63 Heating Cylinder
64 Heater
65 Screw
66 Motor
68 Gas Supply Pipe
70 Head
90 Collecting Net
95 Fine Fiber
100 Processing Device
101 Spindle
102 Processing Tool
103 Cable Tie
d Average Fiber Diameter
d_{g} Average Particle Diameter of Abrasive Particles
e₁ Interfiber Distance
η Porosity
W Object to be Polished
Ra Arithmetic Average Roughness
M_{P} Removal Amount from Polishing

1. A polishing nanofiber aggregate configured to be used by adsorbing a slurry prepared by mixing fine powder for precision polishing with a liquid, wherein
formulae (i) and (ii) below are satisfied where the polishing nanofiber aggregate has an average fiber diameter of d and a porosity of η.
(i) 400 nm≤d≤1000 nm
(ii) 0.70≤η≤0.95

2. The polishing nanofiber aggregate according to claim 1, wherein a formula (iii) below is satisfied where the fine powder for precision polishing has an average particle diameter of dg.
$$\begin{matrix}[ Math . 1 ] & \\ \frac{d}{{d}_{g}} ( \sqrt{\frac{3 π}{4 ( 1 - η )} - 1} ) < 1 & ( iii )\end{matrix}$$

3. A method for producing a polishing nanofiber aggregate configured to be used by adsorbing a slurry prepared by mixing fine powder for precision polishing with a liquid, the method comprising the steps of:
aggregating nanofibers having an average fiber diameter of d; and
forming the aggregated nanofibers to have a porosity of ii, wherein
the porosity η satisfies a formula (iv) below where the fine powder for precision polishing has an average particle diameter of dg.
$$\begin{matrix}[ Math . 2 ] & \\ η < 1 - \frac{3 π}{4 {( \frac{{d}_{g}}{d} + 1 )}^{2}} & ( iv )\end{matrix}$$
